(19) United States
(12) Patent Application Publication
(10) Pub. No.: US 2009/0198491 A1
(43) Pub. Date: Aug. 6, 2009

(54) LSP VECTOR QUANTIZATION APPARATUS, LSP VECTOR INVERSE-QUANTIZATION APPARATUS, AND THEIR METHODS

(75) Inventors: Kaoru Sato, Kanagawa (JP); Toshiyuki Morii, Kanagawa (JP); Tomofumi Yamanashi, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/300,225

(22) PCT Filed: May 11, 2007
(86) PCT No.: PCT/JP2007/059709

§ 371 Date: Nov. 10, 2008

(30) Foreign Application Priority Data
May 12, 2006 (JP) 2006-134222

(51) Int. Cl. G10L 19/06

(52) U.S. Cl. 704/219; 704/E19.025

(57) ABSTRACT

Disclosed is an LPC vector quantization device capable of quantizing an LSP vector by using correlation between divided vectors. The device includes: a vector dividing unit (101) for dividing an inputted LSP vector into a first divided vector and a second divided vector; a first quantization unit (102) for quantizing the first divided vector by using a first codebook formed by a plurality of first code vectors to generate a first code; a prediction vector selection unit (103) for predicting a second divided vector from the first code by using a prediction codebook formed by a plurality of prediction code vectors to create a prediction vector; a prediction residual generation unit (104) for obtaining a residual between the prediction vector and the second divided vector to create a prediction residual vector; a second quantization unit (105) for quantizing the prediction residual vector by using a second codebook formed by a plurality of second code vectors to create a second code; and a multiplexing unit (106) for generating a quantization vector code by multiplexing the first code and the second code.

### TECHNICAL FIELD

The present invention relates to an LSP (line Spectral Pairs) vector quantization apparatus, LSP vector dequantization apparatus, and vector quantization and dequantization method for vector-quantization of LSP parameters. In particular, the present invention relates to an LSP vector quantization apparatus, LSP vector dequantization apparatus, and vector quantization and dequantization method for vector-quantization of LSP parameters that are used in a speech encoding and decoding apparatus that transmits speech signals in fields of a packet communication system represented by Internet communication and a mobile communication system.

### BACKGROUND ART

In the field of digital radio communication, packet communication represented by Internet communication and speech storage, speech signal encoding and decoding techniques are essential for effective use of the channel capacity of radio waves and storage media. In particular, a CELP speech encoding and decoding technique is used as a mainstream technique (for example, see non-patent document 1).

A CELP speech encoding apparatus encodes an input speech based on pre-stored speech models. To be more specific, the CELP speech encoding apparatus separates a digital speech signal into frames of regular time intervals, for example, frames of approximately 10 to 20 ms, performs a linear prediction analysis of the speech signal on a per frame basis, finds the linear prediction coefficients (“LPC's”) and a linear prediction residual vector, and encodes the linear prediction coefficients and the linear prediction residual vector individually. As a method of encoding linear prediction coefficients, a CELP speech encoding apparatus generally employs a method of converting the linear prediction coefficients into line spectral pair (“LSP”) parameters and encoding the LSP parameters. As a method of encoding LSP parameters, a CELP speech encoding apparatus is likely to vector-quantize LSP parameters (e.g., see Non-Patent Document 2). As a method of vector quantization, to reduce the amount of calculations in vector quantization, split vector quantization is likely to be used. Split vector quantization means to split a vector to be quantized into two or more and quantize these split vectors individually.

Non-Patent Document 1: M. R. Schroeder, B. S. Atal, “Code Excited Linear Prediction: High Quality Speech at Low Bit Rate,” IEEE proc., ICASSP, 1985, p. 937-940
Non-Patent Document 2: Allen Gersho, Robert M. Gray et al., “vector quantization and information compression,” published by Colona company, p. 237-261

### DISCLOSURE OF INVENTION

### Problem to be Solved by the Invention

An LSP parameter generally has significant correlation between the higher order (meaning the high frequency domain) and the lower order (meaning the low frequency domain) of a vector. However, when an LSP parameter is split into two or more and these split vectors are quantized individually using the above conventional method, information about the correlation between the higher order and the lower order of a vector is lost by splitting the vector and cannot be used for encoding. Therefore, in a technique of applying split vector quantization to an LSP parameter, there is a problem of degrading the performance of speech encoding by the conventional method.

It is therefore an object of the present invention to provide an LSP vector quantization apparatus, LSP vector dequantization apparatus, LSP vector quantization method and LSP dequantization method for splitting an LSP parameter into two or more and quantizing these split vectors keeping correlation between two or more split vectors.

### Means for Solving the Problem

The LSP vector quantization apparatus of the present invention employs a configuration having: a vector splitting section that splits an input line spectral pair vector into a first split vector and a second split vector; a first quantization section that quantizes the first split vector to generate a first code using a first codebook; and a predicting section that predicts the second split vector from the first code to generate a predictive vector using a predictive codebook.

### ADVANTAGEOUS EFFECT OF THE INVENTION

According to the present invention, it is possible to split an LSP parameter vector (hereinafter simply “LSP vector”) into a plurality and quantize these, and quantize information about the correlation between the plurality of split vectors acquired by split, thereby improving the performance of speech encoding.

### BRIEF DESCRIPTION OF DRAWINGS

FIG. 1 is a block diagram showing main components of an LSP vector quantization apparatus according to Embodiment 1;

FIG. 2 illustrates an example case where an LSP vector of the sixth order is split into the first split vector and the second split vector in a vector splitting section according to Embodiment 1;

FIG. 3 illustrates a format of vector quantization processing of an LSP vector quantization apparatus according to Embodiment 1;

FIG. 4 illustrates an example of the association relationships between the first codebook and the predictive codebook according to Embodiment 1;

FIG. 5 is a block diagram showing main components of an LPC vector dequantization apparatus according to Embodiment 1;

FIG. 6 illustrates a format of vector dequantization processing in an LSP vector dequantization apparatus according to Embodiment 1;

FIG. 7 illustrates a format of processing of splitting an LSP vector into three and quantizing these as a variation of Embodiment 1;

FIG. 8 is a block diagram showing main components of an LSP vector quantization apparatus according to Embodiment 2; and

FIG. 9 is a block diagram showing main components of an LSP vector dequantization apparatus according to Embodiment 2.

### BEST MODE FOR CARRYING OUT THE INVENTION

Embodiments of the present invention will be explained below in detail with reference to the accompanying drawings.

### Embodiment 1

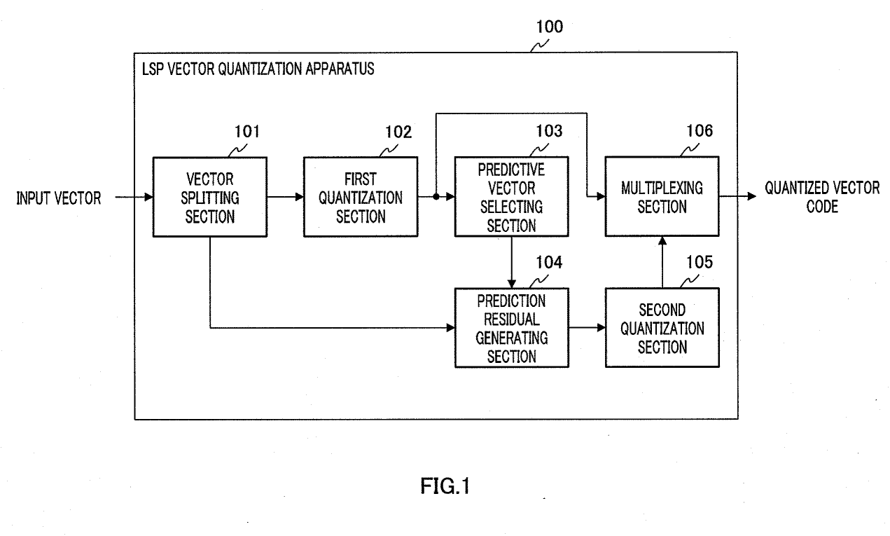

FIG. 1 is a block diagram showing main components of LSP vector quantization apparatus 100 according to Embodiment 1 of the present invention. Here, an example case will be explained where LSP vector quantization apparatus 100 splits an input LSP vector into two, quantizes one split vector, and, using the quantization result, predicts the other split vector, further calculates a prediction error and quantizes the calculated error.

LSP vector quantization apparatus 100 is configured with vector splitting section 101, first quantization section 102, predictive vector selecting section 103, prediction residual generating section 104, second quantization section 105 and multiplexing section 106.

Vector splitting section 101 splits an input LSP vector into two to generate the two split vectors. Vector splitting section 101 outputs the lower order vector supporting the lower frequency domain to first quantization section 102 as the first split vector and outputs the higher order vector supporting the higher frequency domain to prediction residual generating section 104 as the second split vector.

First quantization section 102 incorporates a first codebook comprised of a plurality of first code vectors, and quantizes the first split vector inputted from vector splitting section 101 using the incorporated first codebook and outputs the acquired first code to predictive vector selecting section 103 and multiplexing section 106.

Predictive vector selecting section 103 incorporates a predictive codebook comprised of a plurality of predictive code vectors and selects one predictive code vector from the predictive codebook, based on the first code inputted from first quantization section 102. Predictive vector selecting section 103 outputs the selected predictive code vector as a predictive vector, to prediction residual generating section 104.

Prediction residual generating section 104 calculates the residual between the second split vector inputted from vector splitting section 101 and the predictive vector inputted from predictive vector selecting section 103, and outputs the calculated residual as the prediction residual vector, to second quantization section 105.

Second quantization section 105 incorporates a second codebook comprised of a plurality of second code vectors, and quantizes the prediction residual vector inputted from prediction residual generating section 104 using the second codebook and outputs the acquired second code to multiplexing section 106.

LSP vector quantization apparatus 100 performs the following operations.

An example case will be explained below where the order of the LSP vector to be quantized is R. An LSP vector is expressed by LSP(i) (i=0, 1, . . . , R−1) and the frequency of LSP(i) becomes higher when i becomes larger.

Vector splitting section 101 splits input LSP(i) (i=0, 1, . . . , R−1) into the first vector of the R_P order and the second split vector of the R_F order according to following equation 1.

$$\begin{matrix}[ 1 ] & \\ \begin{matrix}LSP\_P ( i ) = LSP ( i ) & ( i = 0 , … , R\_P - 1 ) \\ LSP\_F ( i ) = LSP ( i + R\_P ) & ( i = 0 , … , R\_F - 1 )\end{matrix} \} & ( Equation 1 )\end{matrix}$$

Here, the sum of R_P and R_F is R, that is, the relationship R_P+R_F=R is satisfied. Vector splitting section 101 outputs LSP_P(i) (i=0, 1, . . . , R_P−1) as the first vector to first quantization section 102, and outputs LSP_F(i) (i=0, 1, . . . , R_F−1) as the second split vector to prediction residual generating section 104.

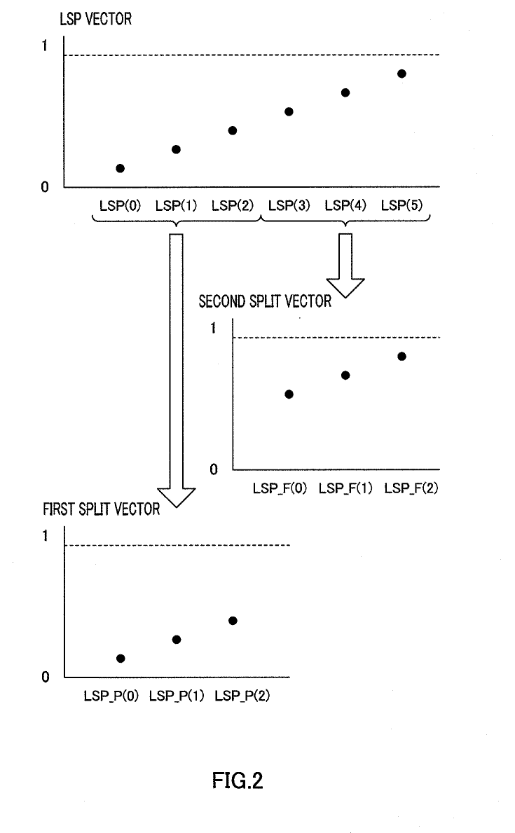

FIG. 2 illustrates an example case where vector splitting section 101 splits an LSP vector of the sixth order into the first split vector and the second split vector. As shown in this figure, in accordance with an increase of the order i, the value of each component LSP(i) (i=0, 1, . . . , 5) of the LSP vector tends to increase in the range between 0 and 1. In a case where such LSP vector of the sixth order is split into the first split vector of the third order and the second split vector of the third order, the first three orders of the LSP vector represent the first split vector LSP_P(i) (i=0, 1, 2) and the second three orders of the LSP vector represent the second split vector LSP_F(i) (i=0, 1, 2).

First quantization section 102 calculates the square error between the first split vector LSP_P(i) (i=0, 1, . . . , R_P−1) inputted from vector splitting section 101 and each first code vector CODE_P^{(m)} (i) (m=0, 1, . . . , M−1, i=0, 1, . . . , R_P−1), according to following equation 2.

$$\begin{matrix}[ 2 ] & \\ {Err\_P}^{( m )} = {\sum }_{i = 0}^{R\_P - 1} {( LSP\_P ( i ) - {CODE\_P}^{( m )} ( i ) )}^{2} & ( Equation 2 )\end{matrix}$$

Here, m is the index of each first code vector forming the first codebook and M is the total number of first code vectors forming the first codebook. First quantization section 102 calculates the square error Err_P^{(m)} (m=0, 1, . . . , M−1) associated with M first code vectors, and outputs the value m_min of m in the minimum square error Err_P^{(m)} as the first code to predictive vector selecting section 103 and multiplexing section 106. That is, first quantization section 102 selects the first code vector maximizing the similarity between the first code vector and the first split vector from the first codebook.

Predictive vector selecting section 103 selects the predictive vector PRED^{(m}^{_{—}}^{min)}(i) (i=0, 1, R_F−1) associated with the first code m_min inputted from first quantization 102, from the predictive vectors PRED^{(m)}(i) (m=0, 1, . . . , M−1, i=0, 1, . . . , R_F−1) forming the incorporated predictive codebook. Here, as an example, the predictive codebook is comprised of M predictive vectors corresponding to the first code vectors included in the first codebook, that is, a predetermined predictive vector is associated with a predetermined first code vector in one-to-one association. Predictive vector selecting section 103 outputs the selected predictive vector PRED^{(m}^{_{—}}^{min)}(i) (i=0, 1, . . . , R_F−1) to prediction residual generating section 104.

Prediction residual generating section 104 calculates the vector error PRED_ERR(i) (i=0, 1, R_F−1) between the second split vector LSP_F(i) (i=0, 1, . . . , R_F−1) inputted from vector splitting section 101 and the predictive vector PRED^{(m}^{_{—}}^{min)}(i) (i=0, 1, R_F−1) inputted from predictive vector selecting section 103, according to following equation 3.

[3]

PRED_ERR(i)=LSP_{—}F(i)−PRED^{(m}^{_{—}}^{min)}(i)(i=0, . . . , R_{—}F−1) (Equation 3)

Prediction residual generating section 104 outputs the calculated PRED_ERR(i) (i=0, 1, . . . , R_F−1) as the prediction residual vector to second quantization section 105.

Second quantization section 105 calculates the square error Err_F⁽ⁿ⁾(n=0, 1, . . . , N−1) between the prediction residual vector PRED_ERR(i) (i=0, 1, R_F−1) inputted from prediction residual generating section 104 and each second code vector CODE_F⁽ⁿ⁾(i) (i=0, 1, . . . , R_F−1, n=0, 1, . . . , N−1) forming the incorporated second codebook, according to following equation 4.

$$\begin{matrix}[ 4 ] & \\ {Err\_F}^{( n )} = {\sum }_{i = 0}^{R\_F - 1} {( PRED\_ERR ( i ) - {CODE\_F}^{( n )} ( i ) )}^{2} & ( Equation 4 )\end{matrix}$$

Here, n is the index of each second code vector forming the second codebook, and N is the total number of the second code vectors forming the first codebook. In the calculated N square errors Err_F⁽ⁿ⁾ (n=0, 1, . . . , N−1), second quantization section 105 outputs the value n_min of n in the minimum square error Err_F⁽ⁿ⁾ as the second code to multiplexing section 106.

Multiplexing section 106 multiplexes the first code m_min inputted from first quantization section 102 and the second code n_min inputted from second quantization section 105, and transmits the acquired quantized vector code to the LSP vector dequantization apparatus.

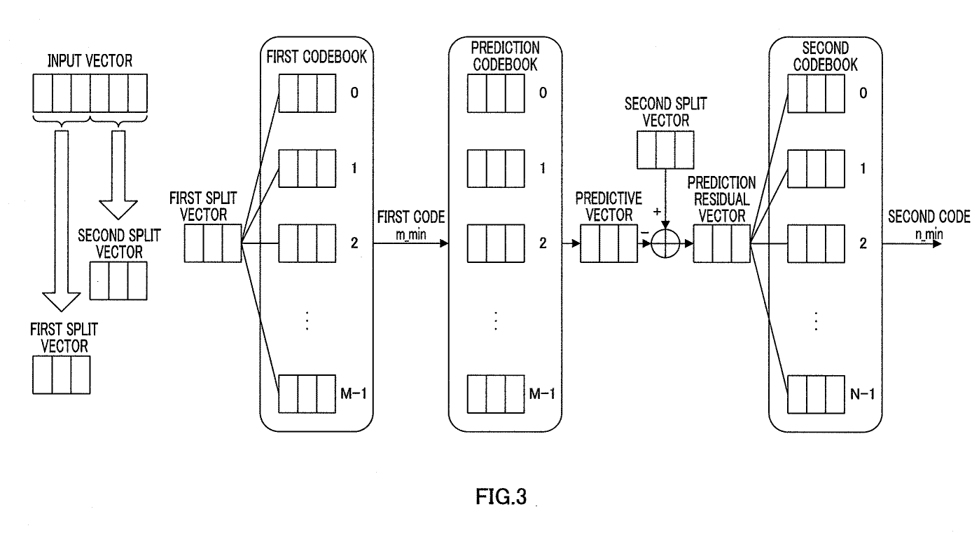

FIG. 3 illustrates a format of vector quantization processing in LSP vector quantization apparatus 100.

In LSP vector quantization apparatus 100, first, vector splitting section 101 splits an input vector into the first split vector and the second split vector. Next, first quantization section 102 compares the first code vectors forming the first codebook and the first split vector, selects the first code vector of the highest similarity with the first split vector, for example, the first code vector in the minimum square error between the first code vector and the first split vector, and determines the index m_min of the selected first code vector as the first code. Next, predictive vector selecting section 103 selects the predictive code vector associated with the first code m_min from the predictive codebook and determines the selected predictive code vector as the predictive vector. Next, prediction residual generating section 104 calculates the residual between the second split vector and the predictive vector, and uses the residual as the prediction residual vector. Next, second quantization section 105 compares the second code vectors forming the second codebook and the prediction residual vector, selects the second code vector of the highest similarity with the prediction residual vector, for example, the second code vector in the minimum square error between the second code vector and the prediction residual vector, and determines the index n_min of the selected second code vector as the second code. Next, multiplexing section 106 multiplexes the first code m_min and the second code n_min.

The first codebook, predictive codebook and second codebook used in LSP vector quantization apparatus 100 are prepared and created in advance by learning, and the method of learning these codebooks will be explained.

To prepare the first codebook included in first quantization section 102 by learning, first, V LSP vectors acquired from V speech data for learning are prepared, and V first split vectors LSP_P^{(v)}(v=0, 1, . . . , V−1, i=0, 1, . . . , R_P−1) are generated using these V LSP vectors according to above equation 1. Next, M first code vectors CODE_P^{(m)}(i) (m=0, 1, . . . , M−1, i=0, 1, . . . , R_P−1) are calculated using V first split vectors LSP_P^{(v)}(i) (v=0, 1, . . . , V−1, i=0, 1, R_P−1) generated above according to learning algorithms such as the LBG (Linde Buzo Gray) algorithm, to generate the first codebook.

To prepare the predictive codebook included in predictive vector selecting section 103 by learning, first, a number of, for example, V′ LSP vectors are calculated from V′ speech data for learning. Next, V′ first split vectors LSP_P^{(v′)} (i) (v′=0, 1, . . . , V′−1, i=0, 1, . . . , R_P−1) and V′ second split vectors LSP_F^{(v′)} (i) (v′=0, 1, . . . , V′−1, i=0, 1, . . . , R_F−1) are generated according to above equation 1 using V′ LSP vectors calculated. Here, the first split vectors and the second split vectors form V′ split vector pairs in one-to-one association. Next, for the first split vector, for example, for LSP_P^{(VS′)} (i) (where vₛ′ is an integral of 0≦vₛ′≦V′−1), the index of the first code vector CODE_P^{(ms)} (i) (where mₛ is an integral of 0≦mₛ≦M−1) in the minimum square error between LSP_P^{(vs′)} (i) and the first code vector CODE_P^{(ms)}(i) is found as the first code m_min from the first codebook, according to above equation 2. By repeating the same processing, the first codes m_min associated with all first split vectors LSP_P^{(v′)}(i) are found and stored. Next, more than one first split vector LSP_P^{(v′)}(i) are extracted where the index ms of the first code vector of the first codebook, for example, CODE_P^{(ms)} (i) (where mₛ is an integral of 0≦mₛ≦M−1), is used as the first code m_min. Next, the second split vectors LSP_F^{(v′)} (i) forming split vector pairs with the extracted first split vectors LSP_P^{(v′)} (i), are extracted. Next, the center (centroid) vector of more than one extracted second split vectors LSP_F^{(v′)}(i) is found and used as the predictive code vector PRED^{(ms)}(i) (i=0, 1, . . . , R_F−1) associated with the index mₛ. By repeating the same processing, predictive code vectors PRED^{(m)}(i) (m=0, 1, . . . , M−1, i=0, 1, . . . , R_F−1) associated with the indexes m's of all first code vectors CODE_P^{(m)}(i) are found to generate the predictive codebook.

In other words, more than one first split vector are extracted in association with the same first code acquired by performing first split vector quantization using the first codebook comprised of M first code vectors and V′ first split vectors. Next, the second split vectors forming split vector pairs with the extracted first split vectors are extracted, and the center (centroid) of the extracted second split vectors is found and used as the predictive code vector. Thus, all predictive code vectors in association with the indexes m's (m=0, 1, . . . , M−1) of the first code vectors of the first codebook are found to generate the predictive codebook.

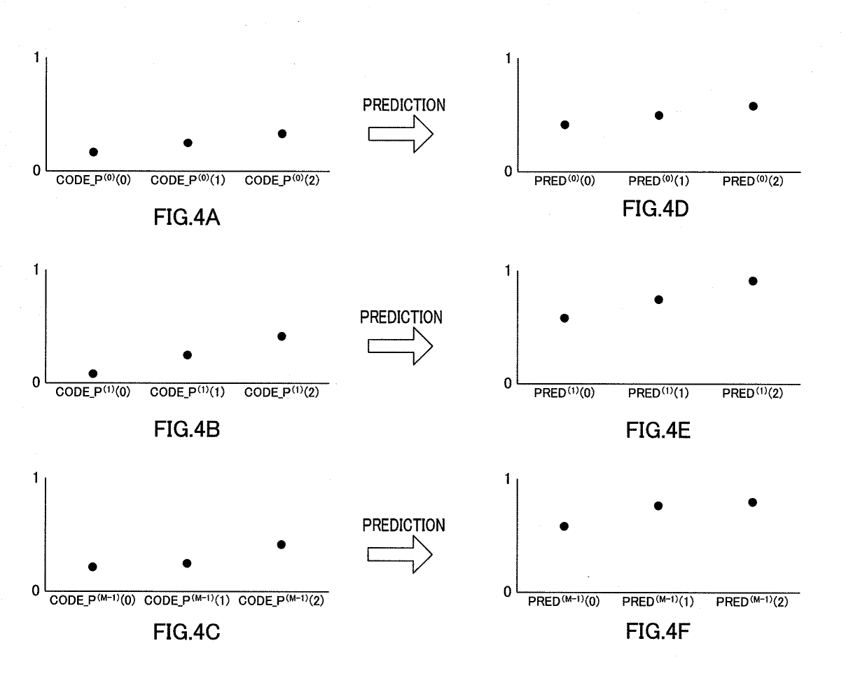

FIG. 4 illustrates an example of the relationships between the first codebook and the predictive codebook.

As shown in this figure, the first codebook is comprised of M types of first code vectors. These M types of first code vectors are found from a number of first split vectors for learning and are representative and typical patterns of the first split vectors. For example, FIG. 4A illustrates a pattern where the value of the elements of the first split vector increases linearly at a relatively slow pace from the lower order to the higher order, and FIG. 4B illustrates a pattern where the value of the elements of the first split vector increases linearly at a relatively fast pace from the lower order to the higher order. Further, FIG. 4C illustrates an example where the value of the elements of the first split vector increases non-linearly from the lower order to the higher order.

As shown in FIG. 4, the predictive codebook is comprised of M types of predictive code vectors associated with the first code vectors forming the first codebook. That is, the predictive code vectors and first code vectors are associated in one-to-one association. For example, the predictive code vectors shown in FIG. 4D are associated with the first code vectors shown in FIG. 4A, and can be predicted from the first split vector. Similarly, the predictive code vectors shown in FIG. 4E are associated with the first code vectors shown in FIG. 4B, and the predictive code vectors shown in FIG. 4F are associated with the first code vectors shown in FIG. 4C.

Thus, by finding the first codebook and the predictive codebook, the second codebook used in second quantization section 105 can be found by learning, using the found first codebook and predictive codebook. To be more specific, first, the first codebook and the predictive codebook are created as described above, and a number of, for example, W LSP vectors are found from W learning speech data. Next, according to equation 1, W split vector pairs formed by the first split vectors LSP_P^{(w)}(i) (w=0, 1, . . . , W−1, i=0, 1, . . . , R_P−1) and the second split vectors LSP_F^{(w)}(i) (w=0, 1, . . . , W−1, i=0, 1, . . . , R_F−1), are generated using W found LSP vectors. Next; first split vector quantization is performed for W split vector pairs, individually. For example, for the wₛ-th (0≦wₛ=≦W−1) split vector pair, the first code m_min is found according to equation 2. Next, the predictive vector PRED^{(m}^{_{—}}^{min)}(i) (i=0, 1, . . . , R_F−1) associated with the found first code m_min is selected from the predictive codebook. Next, the error between the second split vector LSP_F^{(ws)}(i) (i=0, 1, . . . , R_F−1) and the predictive vector PRED^{(m}^{_{—}}^{min)}(i) (i=0, 1, . . . , R_F−1) is calculated as prediction residual vector PRED_ERR^{(ws)}(i) (i=0, 1, . . . , R_F−1). By repeating the same processing, w prediction residual vectors PRED_ERR^{(w)}(i) (w=0, 1, . . . , w−1, i=0, 1, . . . , R_F−1) associated with W split vector pairs are found. Next, N second code vectors are found by learning algorithms such as the LBG algorithm using w prediction residual vectors PRED_ERR^{(w)}(i) (w=0, 1, . . . , W−1, i=0, 1, . . . , R_F−1) acquired, to generate the second codebook.

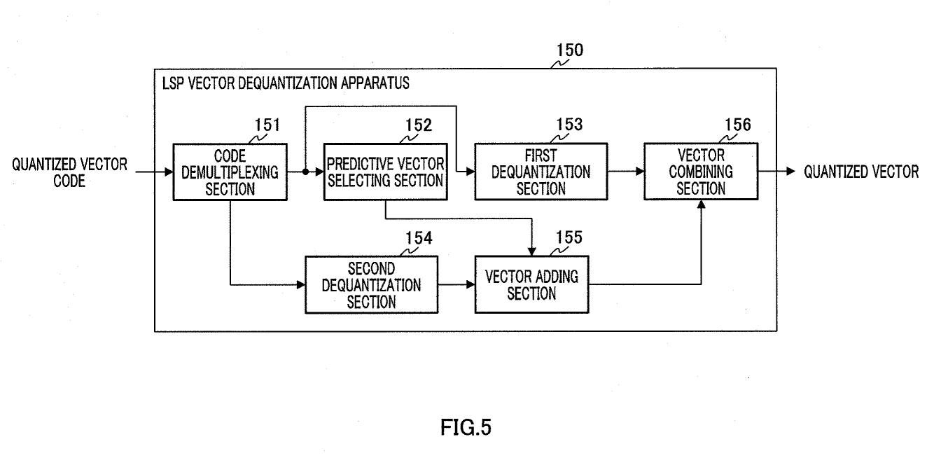

FIG. 5 is a block diagram showing main components of LSP vector dequantization apparatus 150 according to Embodiment 1 of the present invention.

LSP vector dequantization apparatus 150 is configured with code demultiplexing section 151, predictive vector selecting section 152, first dequantization section 153, second dequantization section 154, vector adding section 155 and vector combining section 156. Further, predictive vector selecting section 152 has the same predictive codebook as the codebook of predictive vector selecting section 103, first dequantization section 153 has the same first codebook as the first codebook of first quantization section 102, and second dequantization section 154 has the same second codebook as the second codebook of second quantization section 105.

Code demultiplexing section 151 receives as input the quantized vector code transmitted from LSP vector quantization apparatus 100 and performs demultiplexing processing on the inputted quantized vector code into the first code and the second code. Code demultiplexing section 151 outputs the first code to predictive vector selecting section 152 and first dequantization section 153, and the second code to second dequantization section 154.

Predictive vector selecting section 152 selects a predictive vector from the incorporated predictive codebook based on the first code inputted from code demultiplexing section 151 and outputs the selected predictive vector to vector adding section 155.

First dequantization section 153 dequantizes the first code inputted from code demultiplexing section 151 using the incorporated first codebook, and outputs the acquired first quantized split vector to vector combining section 156.

Second dequantization section 154 dequantizes the second code inputted from code demultiplexing section 151 using the incorporated second codebook, and outputs the acquired quantized prediction residual vector to vector adding section 155.

Vector adding section 155 adds the predictive vector inputted from predictive vector selecting section 152 and the quantized prediction residual vector inputted from second dequantization section 154, and outputs the acquired second quantized split vector to vector combining section 156.

Vector combining section 156 combines the first quantized split vector inputted from first dequantization section 153 and the second quantized split vector inputted from vector adding section 155, and outputs the acquired quantized vector.

LSP vector dequantization apparatus 150 performs the following operations.

Code demultiplexing section 151 performs demultiplexing processing on the inputted quantized vector code into the first code m_min and the second code n_min, and outputs the first code m_min to predictive vector selecting section 152 and first dequantization section 153, and the second code n_min to second dequantization section 154.

Predictive vector selecting section 152 selects from the incorporated predictive codebook, the predictive vector PRED^{(m}^{_{—}}^{min)}(i) (i=0, 1, . . . , R_F−1) associated with the first code m_min inputted from code demultiplexing section 151, and outputs the selected predictive vector PRED^{(m}^{_{—}}^{min)}(i) to vector adding section 155.

First dequantization section 153 selects, from the incorporated first codebook, the first code vector CODE_P^{(m}^{_{—}}^{min)}(i) (i=a, 1, . . . , R_P−1) associated with the first code m_min inputted from code demultiplexing section 151, and outputs the selected first code vector CODE_P^{(m}^{_{—}}^{min)}(i) as the first quantized split vector Q_P(i) (i=0, 1, . . . , R_P−1) to vector combining section 156.

Second dequantization section 154 selects, from the incorporated second codebook, the second code vector CODE_F⁽ⁿ^{_{—}}^{min)}(i) (i=0, 1, . . . , R_F−1) associated with the second code n_min inputted from code demultiplexing section 151, and outputs the selected second code vector CODE_F⁽ⁿ^{_{—}}^{min)}(i) as the quantized prediction residual vector to vector adding section 155.

Vector adding section 155 adds the predictive vector PRED^{(m}^{_{—}}^{min)}(i) (i=0, 1, . . . , R_F−1) inputted from predictive vector selecting section 152 and the quantized prediction residual vector CODE_F⁽ⁿ^{_{—}}^{min)}(i) (i=0, 1, . . . , R_F−1) inputted from second dequantization section 154 according to following equation 5, and outputs the acquired vector as the second quantized split vector Q_F(i) (i=0, 1, . . . , R_F−1) to vector combining section 156.

[5]

Q_{—}F(i)=CODE_{—}F⁽ⁿ^{_{—}}^{min)}(i)+PRED^{(m}^{_{—}}^{min)}(i)(i=0, . . . , R_{—}F−1) (Equation 5)

Vector combining section 156 combines the first quantized split vector Q_P(i) (i=0, 1, . . . , R_P−1) inputted from first dequantization section 153 and the second quantized split vector Q_F(i) (i=0, 1, R_F−1) inputted from vector adding section 155 according to following equation 6, and outputs the acquired quantized vector Q(i) (i=0, 1, . . . , R−1).

$$\begin{matrix}[ 6 ] & \\ \begin{matrix}Q ( i ) = {CODE\_P}^{( m\_min )} ( i ) & ( i = 0 , … , R\_P - 1 ) \\ Q ( i + R\_P ) = Q\_F ( i ) & ( i = 0 , … , R\_F - 1 )\end{matrix} \} & ( Equation 6 )\end{matrix}$$

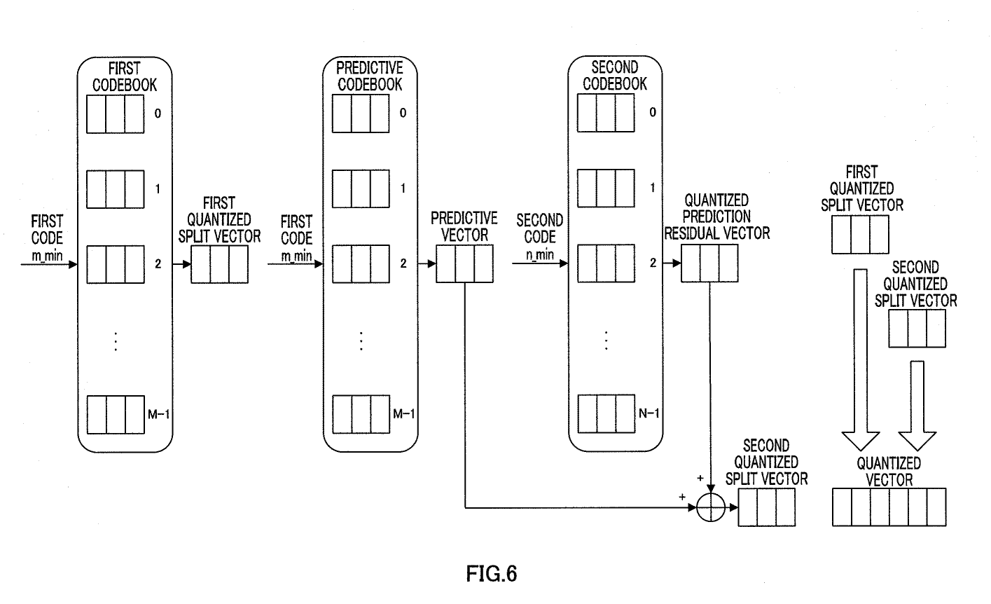

FIG. 6 illustrates a format of vector dequantization processing in LSP vector dequantization apparatus 150.

In LSP vector dequantization apparatus 150, first, first dequantization section 153 selects the first code vector associated with the first code m_min from the first codebook and determines the selected first code vector as the first quantized split vector. Next, predictive vector selecting section 152 selects the predictive vector associated with the first code m_min from the predictive codebook. Next, second dequantization section 154 selects the second code vector associated with the second code n_min from the second codebook and determines the selected second code vector as the quantized prediction residual vector. Next, vector adding section 155 adds the predictive vector and the quantized prediction residual vector, and acquires the second quantized split vector. Next, vector combining section 156 combines the first quantized split vector and the second quantized split vector, to generate a quantized vector.

As described above, according to the present embodiment, by splitting an LSP vector into two split vectors, predicting the second split vector using a quantization result of the first split vector, and quantizing the residual between the predictive vector which is the prediction result and the second split vector, it is possible to use the correlation between the lower order and the higher order of the LSP vector for vector quantization and further improve the accuracy of quantized LSP vector.

Further, although an example case has been described with the present embodiment where the first code vectors in the first codebook and the predictive code vectors in the predictive codebook are associated in one-to-one association, the present invention is not limited to this, and it is equally possible to associate the first code vectors in the first codebook and the predictive code vectors in the predictive codebook in one-to-N (N is an integral equal to or greater than 2) association. In this case, in two or more predictive code vectors associated with the first code, the predictive code vector of the lowest square error to the second split vector should be selected as the prediction residual vector. In this case, the LSP vector quantization apparatus needs to report information as to which predictive vector is selected, to the LSP vector dequantization apparatus. For example, when the number of predictive vectors associated with the first code is 2^{x}, information as to which predictive vector is selected from the 2^{x} predictive vectors should be reported to the LSP dequantization apparatus by transmitting x bits of information.

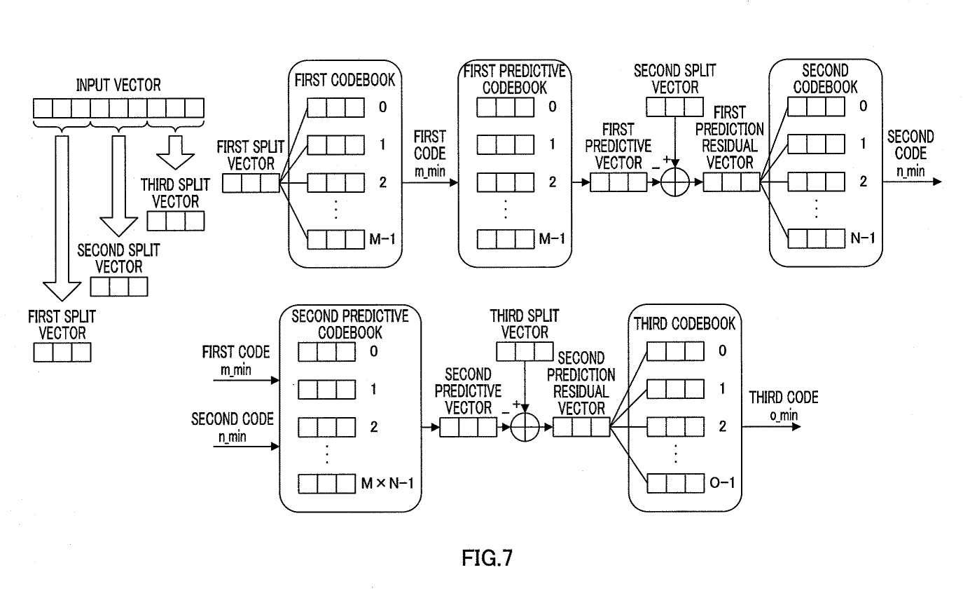

Further, although an example case has been described with the present embodiment where an LSP vector is split into two and quantized, the present invention is not limited to this, and it is equally possible to split an LSP vector into three or more and quantize these split vectors. In this case, upon LSP vector quantization, the first codebook is used to acquire the first code from the first split vector, the first predictive codebook is used to predict the second split vector from the first code, and the second predictive codebook is used to predict the third split vector from the first code and the second code. FIG. 7 illustrates a format of processing of splitting an LSP vector into three and quantizing these split vectors. As shown in this figure, a method of quantizing the first split vector and the second split vector is the same as the method of splitting into two and quantizing an LSP vector as shown in the present embodiment. Next, to quantize the third split vector, first, the third split vector is predicted from the first code and the second code, and the second predictive vector, which is the prediction result, is selected from the second predictive codebook. If the first codebook is comprised of M first code vectors and the second codebook is comprised of N second code vectors, the second predictive codebook has M×N predictive vectors. In splitting into three and quantizing an LSP vector, the second predictive vector is selected in association with the combination of the first code and the second code. Next, the second prediction residual vector which is the residual between the third split vector and the second predictive vector is quantized using the third codebook to acquire the third code o_min.

Further, in splitting into three and quantizing an LSP vector as shown in FIG. 7, the second predictive codebook is comprised of M second predictive vectors associated with the first code vectors, and it is equally possible to predict the third split vector using only the first code.

Further, in splitting into three and quantizing an LSP vector as shown in FIG. 7, the second predictive codebook is comprised of N second predictive vectors associated with the second code vectors, and it is equally possible to predict the third split vector using only the second code.

Further, according to the present embodiment, although the relationship between the bit rate for use to quantize the first split vector and the bit rate for use to quantize the prediction residual vector is not referred to, it is possible to make the bit rate for use to quantize the prediction residual vector lower than the bit rate for use to quantize the first split vector, and further reduce the bit rate for use to quantize the prediction residual vector. By this means, it is possible to reduce the bit rate of speech encoding. In this case, although the accuracy of quantized prediction residual vector deteriorates, the predictive vector is found using the correlation between the first split vector and the second split vector, so that the influence on overall speech encoding due to deterioration of the accuracy of quantized prediction residual vector is relatively little.

Further, although an example case has been described with the present embodiment where the split vector of the higher order is predicted using a quantization result of the split vector of the lower order, the present invention is not limited to this, and it is equally possible to quantize the split vector of the higher order in advance and predict the split vector of the lower order using the quantization result of the split vector of the higher order.

Further, although an example case has been described with the present embodiment where vector quantization is performed for an LSP vector in one step, the present invention is not limited to this, and it is equally possible to perform vector quantization in two or more steps.

Further, although an example case has been described with the present embodiment where an LSP vector is used as a quantization target, a quantization target is not limited to this, and it is equally possible to use vectors other than an LSP vector. In this case, when the correlation between split vectors acquired by splitting a quantization target becomes higher, the quantization accuracy increases.

### Embodiment 2

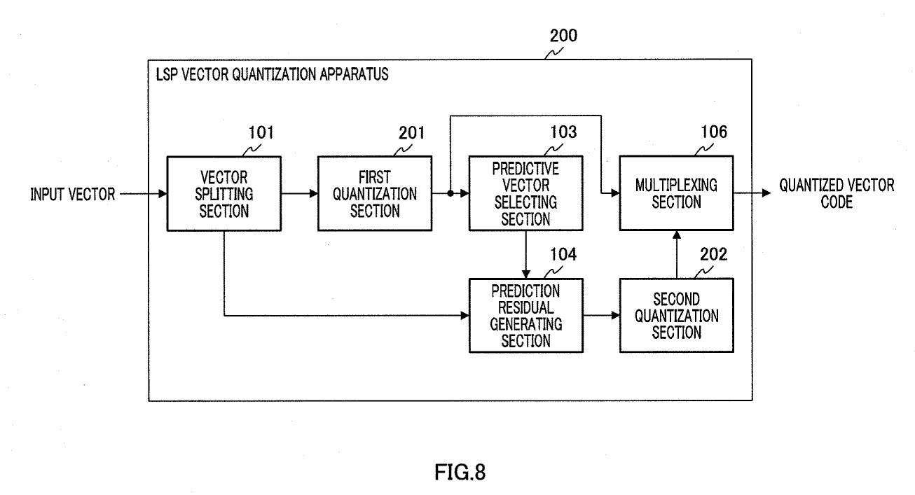

FIG. 8 is a block diagram showing main components of LSP vector quantization apparatus 200 according to Embodiment 2 of the present invention. Further, LSP vector quantization apparatus 200 has the same basic configuration as LSP vector quantization apparatus 100 (see FIG. 1) shown in Embodiment 1, and therefore the same components will be assigned the same reference numerals and explanations will be omitted.

LSP vector quantization apparatus 200 is configured with vector splitting section 101, first quantization section 201, predictive vector selecting section 103, prediction residual generating section 104, second quantization section 202 and multiplexing section 106. First quantization section 201 and second quantization section 202 in LSP vector quantization apparatus 200 perform partly different operations from first quantization section 102 and second quantization section 105 in LSP vector quantization apparatus 100, and therefore are assigned different reference numerals.

First quantization section 201 incorporates the first codebook and further has a buffer storing the first code vectors selected to quantize a plurality of past frames. First quantization section 201 quantizes the first split vector inputted from vector splitting section 101 using the first code vectors stored in the above buffer and the first code vectors in the incorporated first codebook, and outputs the acquired first code to predictive vector selecting section 103 and multiplexing section 106.

Second quantization section 202 incorporates the second codebook and further has a buffer storing the second code vectors selected to quantize a plurality of past frames. Second quantization section 202 quantizes the prediction residual vector inputted from prediction residual generating section 104 using the second code vectors stored in the above buffer and the second code vectors in the incorporated second codebook, and outputs the acquired second code to multiplexing section 106.

To be more specific, first quantization section 201 and second quantization section 202 having the above configurations perform the following operations.

First quantization section 201 calculates the square error Err_P^{(m)}(m=0, 1, . . . , M−1) of the first code vector CODE_P^{(m)}(i) (m=0, 1, . . . , M−1, i=0, 1, R_P−1) in the incorporated first codebook according to following equation 7, using the first split vector LSP_P⁽ⁱ⁾ (i=0, 1, . . . , R_P−1) inputted from vector splitting section 101 and the plurality of first split vectors CODE_Pⱼ(i) (j=0, 1, . . . , M−1, i=0, 1, R_P−1) stored in the incorporated buffer.

$$\begin{matrix}[ 7 ] & \\ {Err\_P}^{( m )} = {\sum }_{i = 0}^{R\_P - 1} {( \begin{matrix}LSP\_P ( i ) - {α\_P}_{0} ( i ) \times \\ {CODE\_P}^{( m )} ( i ) - \\ {\sum }_{j = 1}^{J - 1} {α\_P}_{j} ( i ) \times {CODE\_P}_{j} ( i )\end{matrix} )}^{2} & ( Equation 7 )\end{matrix}$$

Here, m is the index of each first code vector forming the first codebook, and M is the total number of first code vectors forming the first codebook. CODE_Pⱼ (i) is the first code vector selected for quantization j frames earlier. α_Pⱼ(i) (j=0, 1, . . . , J−1, i=0, 1, . . . , R_P−1) is the prediction coefficient between frames. Prediction coefficient α-Pⱼ(i) (j=0, 1, . . . , J−1, i=0, 1, . . . , R_P−1) is found and set in advance by learning such that the square error calculated according to above equation 7 is statistically minimized. To be more specific, first, the first codebook is found by learning, and a number of LSP vectors acquired from a large amount of speech data for learning are prepared to calculate the square error ERR_P^{(m)} of a number of first split vectors acquired from a number of LSP vectors, according to above equation 7. Next, αPⱼ(i) (j=0, 1, J−1, i=0, 1, . . . , R_P−1) is found such that the sum of the calculated square error ERR_P^{(m)} is minimized. Further, prediction coefficient α_Pⱼ(i) (j=0, 1, . . . , J−1, i=0, 1, . . . , R_P−1) satisfies the relationship shown in following equation 8.

$$\begin{matrix}[ 8 ] & \\ {\sum }_{j = 0}^{J - 1} {α\_P}_{j} ( i ) = 1.0 ( i = 0 , … , R\_P - 1 ) & ( Equation 8 )\end{matrix}$$

First quantization section 201 outputs the index m_min of the first code vector in the minimum square error calculated according to above equation 7, as the first code to predictive vector selecting section 103 and multiplexing section 106. Further, first quantization section 201 updates the buffer according to following equation 9.

[9]

CODE_{—}P_{J-1}(i)=CODE_{—}P_{J-2}(i)(i=0, . . . , R_{—}P−1)

CODE_{—}P_{J-2}(i)=CODE_{—}P_{J-3}(i)(i=0, . . . , R_{—}P−1)

.

.

.

CODE_{—}P₃(i)=CODE_{—}P₂(i)(i=0, . . . , R_{—}P−1)

CODE_{—}P₂(i)=CODE_{—}P₁(i)(i=0, . . . , R_{—}P−1)

CODE_{—}P₁(i)=CODE_{—}P^{(m}^{_{—}}^{min)}(i)(i=0, . . . , R_{—}P−1) (Equation 9)

Second quantization section 202 calculates the square error Err_F⁽ⁿ⁾ (n=0, 1, . . . , N−1) of the second code vectors CODE_F⁽ⁿ⁾(i) (n=0, 1, . . . , N−1, i=0, 1, . . . , R_P−1) in the incorporated second codebook according to following equation 10, using the prediction residual vector PRED_ERR(i) (i=0, 1, . . . , R_F−1) inputted from prediction residual generating section 104 and the plurality of second code vectors CODE_Fⱼ(i) (j=0, 1, . . . , N−1, i=0, 1, . . . , R_F−1) stored in the incorporated buffer.

$$\begin{matrix}[ 10 ] & \\ {Err\_F}^{( n )} = {\sum }_{i = 0}^{R\_F - 1} {( \begin{matrix}PRED\_ERR ( i ) - {α\_F}_{0} ( i ) \times \\ {CODE\_F}^{( n )} ( i ) - \\ {\sum }_{j = 1}^{J - 1} {α\_F}_{j} ( i ) \times {CODE\_F}_{j} ( i )\end{matrix} )}^{2} & ( Equation 10 )\end{matrix}$$

Here, n is the index of each second code vector forming the second codebook, and N is the total number of second code vectors forming the second codebook. CODE_Fⱼ(i) is the second code vector selected for quantization j frames earlier, and α_Fⱼ(i) (j=0, 1, . . . , J−1, i=0, 1, . . . , R_F−1) is the prediction coefficient between frames. Prediction coefficient α_Fⱼ (i) (j=0, 1, . . . , J−1, i=0, 1, . . . , R_F−1) is found and set by learning in advance such that the square error calculated according to above equation is statistically minimized. To be more specific, the second codebook is found by learning, and a number of LSP vectors acquired from a large amount of speech data for learning are prepared to calculate the square error ERR_F (n) of a number of second split vectors acquired from a number of LSP vectors, according to above equation 10. Next, α_Fⱼ(i) (j=0, 1, . . . , J−1, i=0, 1, . . . , R_F−1) is found such that the sum of the calculated square error ERR_F⁽ⁿ⁾ is minimized. Further, the prediction coefficient α_Fⱼ(i) (j=0, 1, . . . , J−1, i=0, 1, . . . , R_P−1) satisfies the relationship shown in following equation 11.

$$\begin{matrix}[ 11 ] & \\ {\sum }_{j = 0}^{J - 1} {α\_F}_{j} ( i ) = 1.0 ( i = 0 , … , R\_P - 1 ) & ( Equation 11 )\end{matrix}$$

Second quantization section 202 outputs the index n_min of the second code vector in the minimum square error calculated according to above equation 10, as the second code to multiplexing section 106. Further, second quantization section 202 updates the buffer according to following equation 12.

[12]

CODE_{—}F_{J-1}(i)=CODE_{—}F_{J-2}(i)(i=0, . . . , R_{—}F−1)

CODE_{—}F_{J-2}(i)=CODE_{—}F_{J-3}(i)(i=0, . . . , R_{—}F−1)

.

.

.

CODE_{—}F₃(i)=CODE_{—}F₂(i)(i=0, . . . , R_{—}F−1)

CODE_{—}F₂(i)=CODE_{—}F₁(i)(i=0, . . . , R_{—}F−1)

CODE_{—}F₁(i)=CODE_{—}F^{(m}^{_{—}}^{min)}(i)(i=0, . . . , R_{—}F−1) (Equation 12)

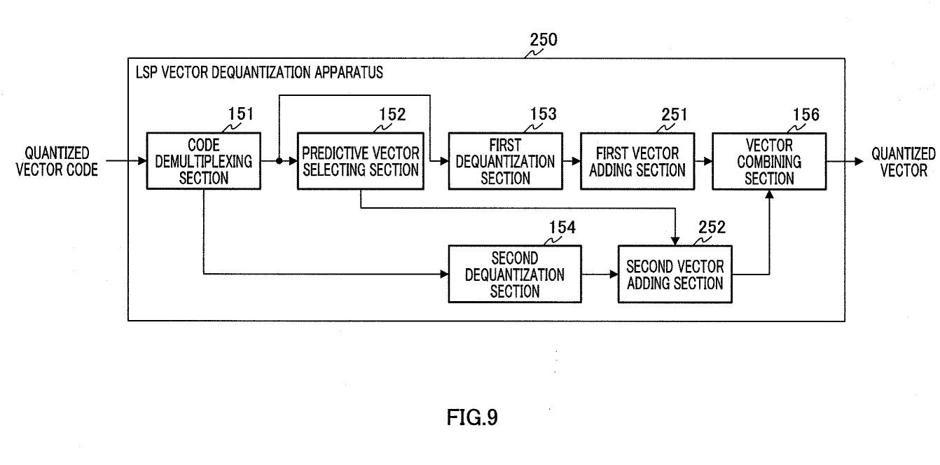

FIG. 9 is a block diagram showing main components of LSP vector dequantization apparatus 250 according to Embodiment 2 of the present invention. Further, LSP vector dequantization apparatus 250 has the same base configuration as in LSP vector dequantization apparatus 150 (see FIG. 5) shown in Embodiment 1, and therefore the same components will be assigned the same reference numerals and explanations will be omitted.

LSP vector dequantization apparatus 250 is configured with code demultiplexing section 151, predictive vector selecting section 152, first dequantization section 153, second dequantization section 154, first vector adding section 251, second vector adding section 252 and vector combining section 156. LSP vector dequantization apparatus 250 is different from LSP vector dequantization apparatus 150 in replacing vector adding section 155 by second vector adding section 252 and further having first vector adding section 251.

First vector adding section 251 has a buffer storing the first code vectors selected in first dequantization section 153 for dequantization of a plurality of past frames. First vector adding section 251 performs addition processing using the first code vectors stored in the above buffer and the first code vectors inputted from first dequantization section 153, and outputs the addition results as the first quantized split vectors to vector combining section 156.

Second vector adding section 252 has a buffer storing the second code vectors selected in second dequantization section 154 for dequantization of a plurality of past frames. Second vector adding section 252 performs addition processing using the second code vectors stored in the above buffer and the second code vectors inputted from second dequantization section 154, and outputs the addition results as the second quantized split vectors to vector combining section 156.

First vector adding section 251 and second vector adding section 252 having the above configurations perform the following operations.

First vector adding section 251 generates the first quantized split vector Q_P(i) (i=0, 1, . . . , R_P−1) according to following equation 13, using the first code vectors CODE_Pⱼ(i) (j=0, 1, . . . , J−1, i=0, 1, R_P−1) stored in the incorporated buffer and the first code vector CODE_P^{(m}^{_{—}}^{min)}(i) (i=0, 1, . . . , R_P−1) inputted from first dequantization section 153.

$$\begin{matrix}[ 13 ] & \\ Q\_P ( i ) = {α\_P}_{0} ( i ) \times {CODE\_P}^{( m\_min )} ( i ) + {\sum }_{i = 1}^{J - 1} {α\_P}_{j} ( i ) \times {CODE\_P}_{j} ( i ) \\ ( i = 0 , … , R\_P - 1 ) & ( Equation 13 )\end{matrix}$$

Here, the inter-frame prediction coefficient α_Pⱼ(i) (j=0, 1, . . . , J−1) is the same as the inter-frame prediction coefficient used in first quantization section 201 in LSP vector quantization apparatus 200. First vector adding section 251 outputs the calculated first quantized split vector Q_P(i) (i=0, 1, . . . , R_P−1) to vector combining section 156, and further updates the buffer according to above equation 9.

Second vector adding section 252 calculates the second quantized split vector Q_F(i) (i=0, 1, R_F−1) according to following equation 14, using the second code vectors CODE_Fⱼ(i) (j=0, 1, . . . , J−1, i=0, 1, . . . , R_P−1) stored in the incorporated buffer, the second code vector CODE_F^{m (i) (i=}0, 1, . . . , R_F−1) inputted from second dequantization section 154, and the predictive vector PRED^{(m}^{_{—}}^{min)}(i) inputted from predictive vector selecting section 152.

$$\begin{matrix}[ 14 ] & \\ Q\_F ( i ) = {α\_F}_{0} ( i ) \times {CODE\_F}^{( n\_min )} ( i ) + {\sum }_{j = 1}^{J - 1} {α\_F}_{j} ( i ) \times {CODE\_F}_{j} ( i ) + {PRED}^{( m\_min )} ( i ) \\ ( i = 0 , … , R\_F - 1 ) & ( Equation 14 )\end{matrix}$$

Here, the inter-frame prediction coefficient α_Fⱼ(i) (j=0, 1, . . . , J−1, i=0, 1, . . . , R_F−1) is the same as the inter-frame prediction coefficient used in second quantization section 202 in LSP vector quantization apparatus 200. Second vector adding section 252 outputs the calculated second quantized split vector Q_F(i) (i=0, 1, . . . , R_F−1) to vector combining section 156, and further updates the buffer according to above equation 12.

As described above, an LSP vector is split into two split vectors, inter-frame prediction is applied to the processing of predicting a second split vector using the quantization result of the first split vector and the processing of further quantizing the residual between the predictive vector, which is the prediction result, and the second split vector, so that it is possible to use the correlation between frames in addition to the correlation between the lower order and the higher order of the LSP vector, thereby improving the accuracy of quantized an LSP vector.

Further, although an example case has been described with the present embodiment where above equation 10 is used as a method which second quantization section 202 in LSP vector quantization apparatus 200 employs to select the second code vector from the second codebook, the method is not limited to this, and it is equally possible to select the second vector according to following equation 15.

$$\begin{matrix}[ 15 ] & \\ Err\_F = {\sum }_{i = 0}^{R\_F - 1} {( \begin{matrix}LSP\_F ( i ) - {α\_F}_{0} ( i ) \times \\ ( \begin{matrix}β \times {CODE\_F}^{( n )} ( i ) + \\ ( 1 - β ) \times {PRED}^{( m\_min )} ( i )\end{matrix} ) - \\ {\sum }_{j = 1}^{J - 1} {α\_F}_{j} ( i ) \times {CODE\_F}_{j} ( i )\end{matrix} )}^{2} & ( Equation 15 )\end{matrix}$$

Here, β(0≦β≦1) is the weighting coefficient for the predictive vector and the second code vector used for addition processing. Further, the value of β can be adaptively changed on a per frame basis. In this case, second vector adding section 252 in LSP vector dequantization apparatus 250 calculates the second quantized split vector according to following equation 16.

$$\begin{matrix}[ 16 ] & \\ Q\_F ( i ) = {α\_F}_{0} ( i ) \times ( \begin{matrix}β \times {CODE\_F}^{( n\_min )} ( i ) + \\ ( 1 - β ) \times {PRED}^{( m\_min )} ( i )\end{matrix} ) + {\sum }^{J - 1} {α\_F}_{j} ( i ) \times {CODE\_F}_{j} ( i ) \\ ( i = 0 , … , R\_F - 1 ) & ( Equation 16 )\end{matrix}$$

Further, in this case, second quantization section 202 and second vector adding section 252 updates the buffer according to following equation 17.

[17]

CODE_{—}F_{J-1}(i)=CODE_{—}F_{J-2}(i)(i=0, . . . , R_{—}F−1)

CODE_{—}F_{J-2}(i)=CODE_{—}F_{J-3}(i)(i=0, . . . , R_{—}F−1)

.

.

.

CODE_{—}F₃(i)=CODE_{—}F₂(i)(i=0, . . . , R_{—}F−1)

CODE_{—}F₂(i)=CODE_{—}F₁(i)(i=0, . . . , R_{—}F−1)

CODE_F₁(i)=β×CODE_{—}F⁽ⁿ^{_{—}}^{min)}(i)+(1−β)×PRED^{(m}^{_{—}}^{min)}(i)(i=0, . . . , R_{—}F−1) (Equation 17)

Further, second quantization section 202 in LSP vector quantization apparatus 200 may select the second code vector from the second codebook according to following equation 18.

$$\begin{matrix}[ 18 ] & \\ Err\_F = {\sum }_{i = 0}^{R\_F - 1} {( \begin{matrix}LSP\_F ( i ) - {α\_F}_{0} ( i ) \times \\ {CODE\_F}^{( n )} ( i ) - \\ {\sum }_{j = 1}^{J - 1} {α\_F}_{j} ( i ) \times {CODE\_F}_{j} ( i ) - \\ γ \times {PRED}^{( m\_min )} ( i )\end{matrix} )}^{2} & ( Equation 18 )\end{matrix}$$

Here, γ(0≦γ≦1) is the coefficient by which the predictive vector is multiplied. Further, the value of γ can be adaptively changed on a per frame basis. In this case, second vector adding section 252 in LSP vector dequantization apparatus 250 calculates the second quantized split vector according to following equation 19.

$$\begin{matrix}[ 19 ] & \\ Q\_F ( i ) = {α\_F}_{0} ( i ) \times {CODE\_F}^{( n\_min )} ( i ) + {\sum }_{j = 1}^{J - 1} {α\_F}_{j} ( i ) \times {CODE\_F}_{j} ( i ) + γ \times {PRED}^{( m\_min )} ( i ) \\ ( i = 0 , … , R\_F - 1 ) & ( Equation 19 )\end{matrix}$$

Further, although an example case has been described with the present embodiment where the inter-frame prediction coefficient takes one type, it is equally possible to prepare a plurality of inter-frame prediction coefficients and select an optimum prediction coefficient on a per frame basis. In this case, information about the prediction coefficient selected in LSP vector quantization apparatus 200 is transmitted to LSP vector dequantization apparatus 250.

Embodiments of the present invention have been described above.

Here, LSP can be referred to as “LSF (Line Spectral Frequency)”, and therefore LSP can be read as LSF. Further, when ISP (Immittance Spectrum Pairs) instead of LSP is quantized as the spectrum parameter, it is equally possible to read LSP as ISP and use an ISP quantization and dequantization apparatus in the present embodiments.

The LSP vector quantization apparatus, LSP vector dequantization apparatus, LSP vector quantization method and LSP vector dequantization method according to the present invention are not limited to above embodiments and can be implemented with various changes.

Further, the LSP vector quantization apparatus and LSP vector dequantization apparatus according to the present invention can be included in a communication terminal apparatus in the mobile communication system for performing speech transmission, so that it is possible to provide a communication terminal apparatus having the same operational effects as above.

Although a case has been described with the above embodiments as an example where the present invention is implemented with hardware, the present invention can be implemented with software. For example, by describing the LSP vector quantization method and LSP vector dequantization method according to the present invention in a programming language, storing this program in a memory and making the information processing section execute this program, it is possible to implement the same function as the LSP vector quantization apparatus and LSP vector dequantization apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-134222, filed on May 12, 2006, including the specification, drawings and abstract, is incorporated herein by reference in its entirety.

### INDUSTRIAL APPLICABILITY

The LSP vector quantization apparatus, LSP vector dequantization apparatus, LSP vector quantization method and LSP vector dequantization method according to the present invention are applicable to speech encoding and speech decoding.

1. A line spectral pair vector quantization apparatus comprising:
a vector splitting section that splits an input line spectral pair vector into a first split vector and a second split vector;
a first quantization section that quantizes the first split vector to generate a first code using a first codebook; and
a predicting section that predicts the second split vector from the first code to generate a predictive vector using a predictive codebook.

2. The line spectral pair vector quantization apparatus according to claim 1, wherein:
the first codebook comprises a plurality of first code vectors;
the predictive codebook comprises a plurality of predictive code vectors; and
the plurality of first code vectors and the plurality of predictive code vectors are associated based on the correlation between an lower order part and a higher order part of the line spectral pair vector.

3. The line spectral pair vector quantization apparatus according to claim 2, wherein:
the first quantization section selects a first code vector maximizing the similarity between the first code vector and the first split vector, from the first codebook and uses an index of the selected first code vector as the first code; and
the predicting section selects a predictive code vector associated with the first code from the predictive codebook and uses the selected predictive code vector as the predictive vector.

4. The line spectral pair vector quantization apparatus according to claim 1, further comprising:
a prediction residual generating section that calculates a residual between the predictive vector and the second split vector, and uses the residual as a prediction residual vector; and
a second quantization section that quantizes the prediction residual vector to generate a second code using a second codebook.

5. The line spectral pair vector quantization apparatus according to claim 4, wherein:
the second codebook comprises a plurality of second code vectors; and
the second quantization section selects a second code vector maximizing the similarity between the second code vector and the prediction residual vector, from the second codebook and uses an index of the selected second code vector as the second code.

6. The line spectral pair vector quantization apparatus according to claim 1, wherein the first quantization section further has a buffer that stores first code vectors selected in a plurality of past frames,
further performs a prediction between frames using the plurality of first code vectors stored in the buffer and quantizes the first split vector.

7. A line spectral pair vector dequantization apparatus comprising:
a first dequantization section that dequantizes a first code transmitted from a line spectral pair vector quantization apparatus to generate a first quantized split vector using a first codebook;
a predicting section that performs a prediction using the first code to generate a second quantized split vector using a predictive codebook; and
a combining section that combines the first quantized split vector and the second quantized split vector to generate a line spectral pair quantized vector.

8. A line spectral pair quantization method comprising the steps of:
splitting an input line spectral pair vector into a first split vector and a second split vector;
quantizing the first split vector to generate a first code using a first codebook; and
predicting the second split vector from the first code to generate a predictive vector using a predictive codebook.

9. A line spectral pair dequantization method comprising the steps of:
dequantizing a first code transmitted from a line spectral pair vector quantization apparatus to generate a first quantized split vector using a first codebook;
performing a prediction using the first code to generate a second quantized split vector using a predictive codebook; and
combining the first quantized split vector and the second quantized split vector to generate a line spectral pair quantized vector.
